(19) United States
(12) Patent Application Publication
(10) Pub. No.: US 2009/0308259 A1
(43) Pub. Date: Dec. 17, 2009

(54) Machine for preparing an infusion that comprises a locking device for an infusion chamber

(75) Inventor: Frederic Hiron, Asse Le Boisne (FR)

Correspondence Address: YOUNG & THOMPSON, 209 Madison Street, Suite 500, Alexandria, VA, 22314, US

(73) Assignee: SEB S.A., ECULLY (FR)

(21) Appl. No.: 11/919,127

(22) PCT Filed: Apr. 13, 2006
(86) PCT No.: PCT/FR2006/000856

§ 371 Date: Oct. 24, 2007

(30) Foreign Application Priority Data
May 4, 2005 (FR) 0504580

(51) Int. Cl. A23F 5/00

(52) U.S. Cl. 99/323.3

(57) ABSTRACT

The inventive infusion machine comprises a housing, a pressurised cold water generator arranged therein, a first infusion chamber (11) delimited by the first and second housing parts and a locking device (40) of said first infusion chamber (11), which comprises a locking control (42), a first locking element (20) rotatably mounted on an axis (VI) and a second locking element (16), wherein said first locking element (20) is arranged in such a way that it is rotatably movable between locked and unlocked positions. A locking lever (50) is mounted in such a way that it is pivotable about an axis (51) which is fixed with respect to the first housing part and is connected to the first locking element (20).

This invention relates to a machine for preparing an infusion that is equipped with a locking device for an infusion chamber. More particularly, the invention relates to a machine that comprises:
A housing that comprises at least a first part and a second part that can be moved relative to one another;
A pressurized hot water generator that is arranged inside the housing;
At least a first infusion chamber that is delimited by the first and second parts of the housing and fed by said generator to infuse a product that is placed inside; and
A device for locking the infusion chamber that comprises a locking control that is connected to a locking lever and that comprises at least a first locking element that is mounted to rotate on an axis, called locking, connected to the first part of the housing, and a second locking element that is attached to the second part of the housing, whereby said first locking element is suitable for being moved by rotation between a locked position, in which said first and second locking elements are engaged with one another, and a second unlocked position, in which said first and second locking elements can be disengaged from one another.

Machines of this type have been produced, in particular in the form of coffeemakers that comprise an infusion chamber that is suitable for holding a dose of coffee grind that is contained in a flexible filter paper packet. The fact of locking the infusion chamber by a relative rotation between two locking elements around an axis, and in particular an axis that extends essentially in the direction of separation of the first and second locking elements during the opening of the infusion chamber, is advantageous for preventing an opening of the infusion chamber under the effect of the increase of the pressure in the latter when the infusion is prepared.

The infusion chamber, however, should remain airtight enough at the junction between the first and second parts of the housing that delimit it to prevent leaks of hot water under pressure. To obtain this sealing, it is possible to provide elastically deformable joints and/or tightening means between the first and second parts of the housing during the locking. However, it turns out that the fact of providing such arrangements for the sealing of the chamber very clearly increases the friction between the first and the second locking elements. It then becomes difficult to obtain tightening or an adequate compression of the sealing joints without the locking of the infusion chamber requiring an unacceptable force for certain users to pass from the unlocked position to the locked position, or vice versa.

The object of this invention is therefore to make possible an airtight and reliable locking of the infusion chamber, while offering a locking control that is easy to manipulate for most users.

For this purpose, the object of this invention is a machine for preparing an infusion of the above-mentioned type, characterized in that the locking lever is mounted to pivot around a stationary axis relative to the first part of the housing and is connected to the first locking element, and said locking element is suitable for bringing said first locking element into rotation around the locking axis relative to the first part of the housing and for exerting on said first locking element a torque that is amplified relative to the torque that is exerted on said lever by the locking control.

Thanks to the effect of torque amplification or else the reduction of displacement amplitude, obtained by the pivoting of the lever around the stationary axis, the force exerted on the locking control is well within the capabilities of most users. It will be noted that to obtain reliable locking with a rotary locking element, the angle of rotation of the latter can be small, for example less than 45 degrees. Consequently, even if the displacement of the locking control is amplified, its amplitude is acceptable for the user for obtaining an effective locking of the infusion chamber.

In preferred embodiments of the invention, technologists also resort to one and/or the other of the following arrangements:
The locking lever comprises a control arm that extends from the pivoting axis to a portion that is connected to the locking control and a first driving arm that extends from said pivoting axis to a portion that is connected to the first locking element at an eccentric point relative to the locking axis of said first element, whereby the length of the control arm is greater than the length of the driving arm;
One of said first and second locking elements comprises lugs that extend radially relative to the locking axis, while the other of said first and second locking elements comprises “L” guides formed in a ring that is coaxial to the locking axis, whereby said guides each have a first longitudinal portion that opens from the side of the locking element that is equipped with lugs, followed by a second circumferential portion in which the corresponding lug engages with the guide;
The guides and the lugs have mutual contact surfaces that respectively have mating projections and recesses when the first and second locking elements are in locked position;
The locking lever has an indexing arm that extends from the pivoting axis to an indexing stop that rests against an elastically deformable element that is connected to the first part of the housing, whereby the pivoting of the lever from the locked or unlocked position causes a deformation of the elastic element in opposition to its return force;
The first part of the housing has a guide along which the locking control can be translated, whereby said locking control is connected in an articulated manner to the locking lever;
A second infusion chamber is provided, and the locking lever is also connected to a first locking element of the second chamber, whereby said lever is suitable for simultaneously bringing into rotation the first respective locking elements of the first and second chambers around their respective locking axes relative to the first part of the housing;
The locking lever comprises a second driving arm that is connected to the first locking element of the second infusion chamber and that extends from the pivoting axis in a collinear direction to the first driving arm, preferably over the same length, whereby the pivoting axis of the lever is parallel to the locking axes of the first and second respective locking elements of the first and second infusion chambers and is located approximately in the center of said locking axes;
The angle that is formed between the first and second driving arms of the lever, on the one hand, and the control arm of said lever, on the other hand, is determined based on the locked and unlocked positions of the locking control such that said first and second driving arms are in approximately symmetrical positions, relative to the plane that comprises the locking axes, between the locked position and the unlocked position of said locking control;
The second part of the housing constitutes a platform that is mounted on the front of the housing, and the first part of the housing constitutes an upper cover that is mounted in an articulated manner on said platform.

Other characteristics and advantages of the invention will emerge during the following description, given by way of nonlimiting example, with reference to the accompanying drawings, in which:

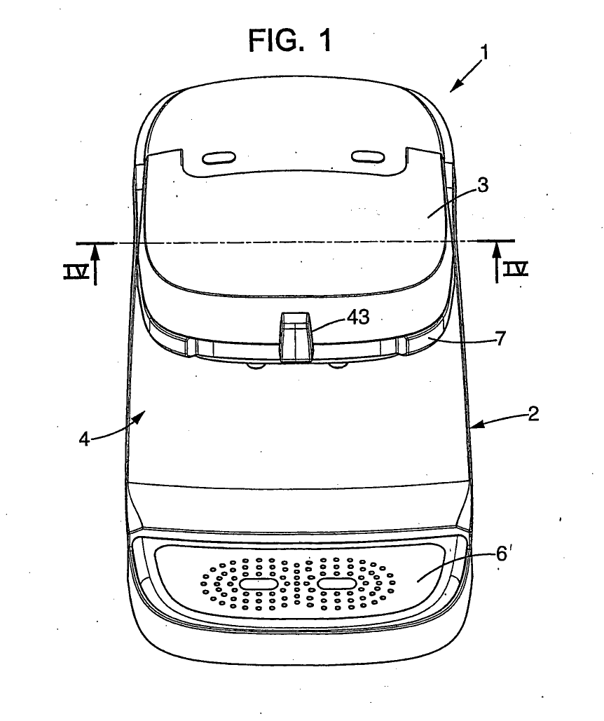

FIG. 1 is a perspective view of a coffeemaker that is produced according to the invention and that has a cover in closed position;

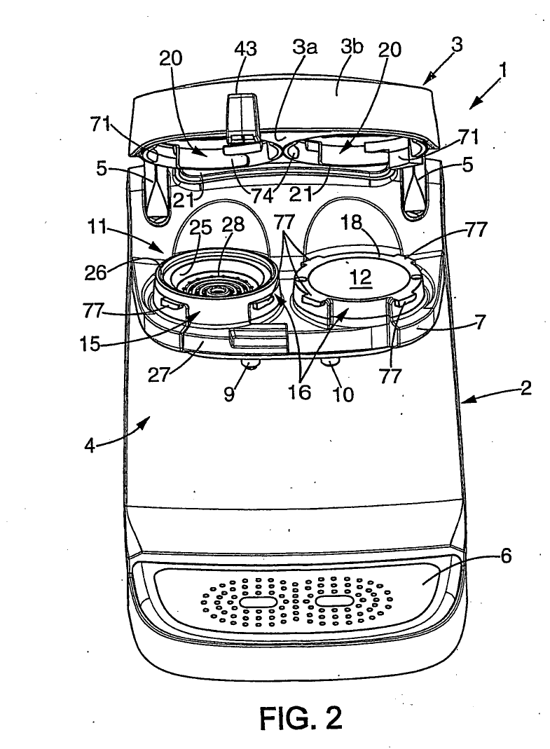

FIG. 2 is a view that is analogous to FIG. 1, in which the cover is in open position;

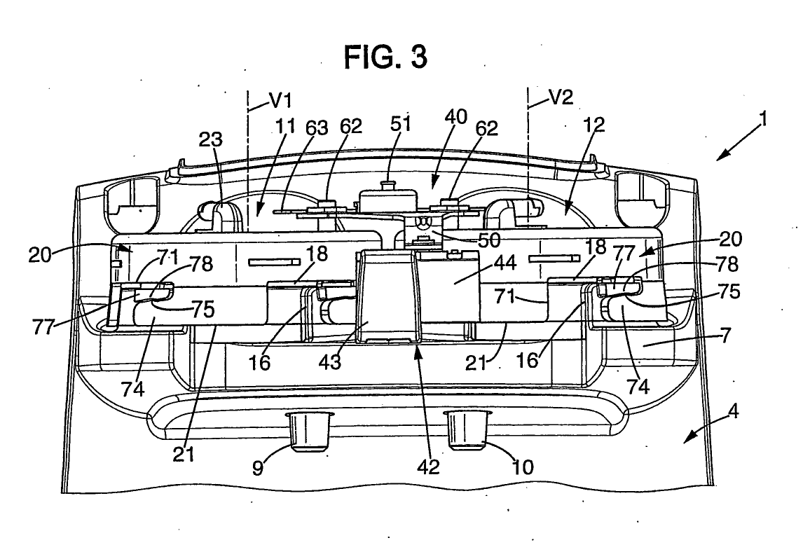

FIG. 3 is a partial cutaway view of the front of the machine shown in FIG. 1;

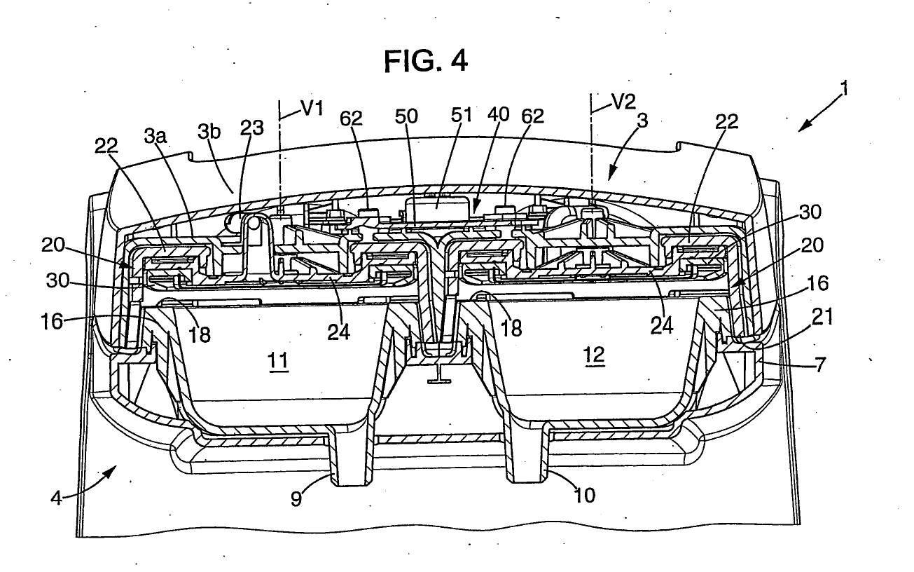

FIG. 4 is a partial view of a vertical section along the line IV-IV of FIG. 1;

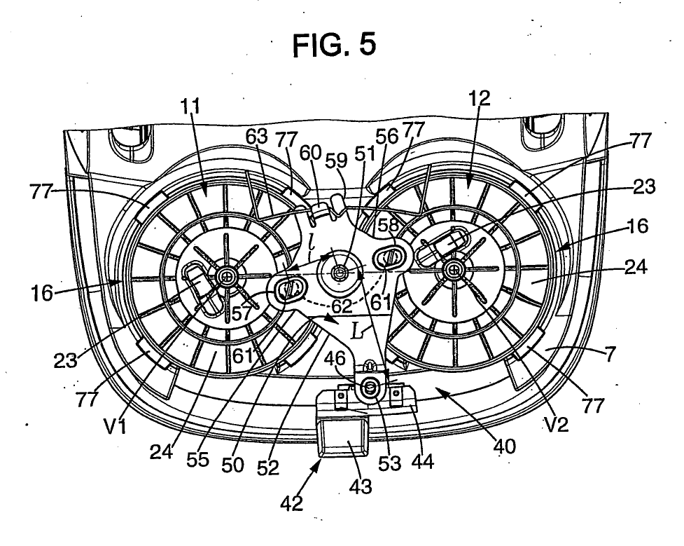

FIG. 5 is a first cutaway view of the top of the cover shown in FIG. 1;

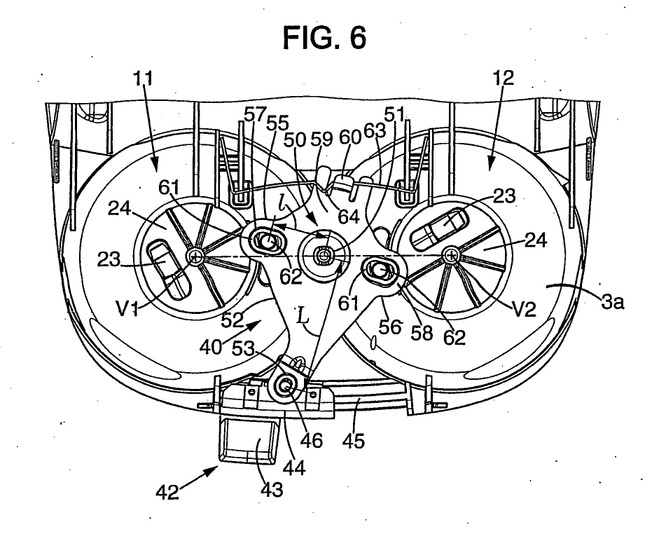

FIG. 6 is a second cutaway view of the top of the cover shown in FIG. 2.

In the different figures, identical references are maintained to designate identical or similar elements.

FIG. 1 shows a coffeemaker 1 that has a housing 2 that comprises a first part 3 and a second part 4. As a better view of this is in FIG. 2, the first part 3 of the housing constitutes a mobile cover between a closed position that is shown in FIG. 1 and an open position that is shown in FIG. 2. The cover 3 is mounted in an articulated manner by means of hinges 5 on the second part 4 of the housing that constitutes a platform. The cover 3 primarily comprises two plastic pieces, namely an inside frame 3a that is visible in FIGS. 2 and 4, and an outside hood 3b that is supported by the frame 3a.

In a known way, the platform 4 contains a pressurized hot water generator, as well as electronic cards and solenoid valves that make it possible to control the operation of the machine.

The platform 4, FIGS. 1 and 2, has a cup-rest plate 6 and a prominent part 7 from which protrude two coffee outlets (9, 10) that are located directly above the cup-rest plate 6.

As is more evident from FIG. 2, the prominent part 7 of the platform 4 and the cover 3 delimit a first infusion chamber 11 and a second infusion chamber 12 that are each designed to accommodate in a removable manner a filter holder 15 such as the one that is shown in the left part of FIG. 2.

Each of the two infusion chambers (11; 12) comprises a trough 16 that has a bottom that is equipped with an opening, from which a tubular element that forms the corresponding coffee outlet (9; 10) and an annular wall that extends from the bottom to an upper perimeter 18 extend. The two infusion chambers (11; 12) are each delimited in their upper part, on the one hand, by a ring 20 that extends from a base 21 to a radially inside flange 22, visible in FIG. 4, and on the other hand, by a sprayer 24 (FIG. 4). Each sprayer 24 comes in the form of a perforated metal disk through which the pressurized water is brought into the infusion chamber, and a counter-disk made of plastic from which there extends a pipe 23 for bringing in water that is lengthened by a flexible tube, which is not shown.

The filter holder 15 that is shown in FIG. 2 comes in the form of a bowl 25 that has a bottom that is equipped with an outlet pipe that is designed to engage in the tubular element that forms the coffee outlet 9, and an annular wall that extends to a collar 26 that is designed to rest on the upper perimeter 18 of the trough 16 and to hold against its upper face the base 21 of the ring 20. The filter holder 15 also comprises a handle 27 that is integral with the bowl 25 and a perforated support 28 that is designed to hold a product to be infused.

In the embodiment that is shown of the filter holder 15, FIG. 2, the product to be infused is an uncompacted coffee grind that is contained in a flexible filter paper packet, which is generally called a dosette. However, the filter holder can be modified for holding a more or less rigid cartridge that contains coffee grind that may or may not be compacted, or for holding the coffee grind directly. It is also possible to provide products to be infused that are different from coffee, such as, for example, tea, chocolate, powdered milk or a mixture of these products, for example for producing coffee with milk or chocolate with milk.

As can be seen in FIG. 4, an annular elastomer seal 30 is placed against the flange 22 of the ring 20 to rest against the collar 26 of the filter holder 15 when it rests on the upper perimeter 18 of the trough 16 of one of the infusion chambers (11; 12). Thus, with the seal 30 and the sprayer 24, the bowl 25 and the collar 26 of the filter holder 15 define an airtight space in which the pressurized hot water is brought through the perforations of the sprayer via the pipe 23.

To keep the infusion chambers 11, 12 in the airtight state as shown in FIGS. 3 and 4, the machine comprises a locking device 40 that comprises a locking control 42 that is formed by a button 43 that projects over the front portion of the cover 3. The control button 43 is integral with a small plate 44, visible in FIGS. 5 and 6, on which only the hood 3b is not shown, which is mounted to move in translation in a linear guide 45 that is conformed in the frame 3a of the cover 3. The hood 3b that constitutes the outside surface of the cover 3 covers the small plate 44 and the guide 45 so that only the button 43 remains visible.

The locking device 40 also comprises a locking lever 50, a better view of which is given in FIGS. 5 and 6. The locking lever 50 is mounted to pivot around a stationary axis 51 that is integral with the frame 3a of the cover 3. The pivoting axis 51 extends essentially vertically when the cover 3 is in closed position.

The locking lever 50 comprises a control arm 52 that extends from the axis of pivoting 51 to a portion 53 that forms a free end, whereby a first and a second driving arm (55, 56) extend from the pivoting axis 51 to portions (57, 58) that form respectively the free end of each of the two driving arms, and one indexing arm 59 that extends from the pivoting axis 51 to a free end that has an indexing stop 60.

In its end portion (53), the control arm 52 has a hole in which is engaged a vertical pin 46 that is integral with the small plate 44 of the locking control 42. Thus, a joint that pivots around an axis that is parallel to the pivoting axis 51 is created between the control arm 52 and the locking control 42. The control arm 52 has an effective length L that corresponds to the distance separating the stationary pivoting axis 51 and the axis of the joint between the control lever 50 and the locking control 42.

In their respective end portion (57, 58), the two driving arms (55, 56) of the lever 50 comprise an opening of clearance 61 that is extended in a radial direction relative to the pivoting axis 51. A driving pin 62 is engaged in each of these two openings 61. The two driving pins 62 each extend vertically from the upper face of the flange 22 of the two rings 20 that delimit respectively the first 11 and second 12 infusion chambers. Thus, a joint that allows a vertical axis pivoting and a sliding movement between the driving arms (55, 56) and the rings 20 of the two infusion chambers (1, 12) is created. The driving arms (55, 56) of the lever 50 thus each have an effective length l that corresponds to the distance between the pivoting axis 51 and the associated driving pin 62, which is clearly less than the effective length L of the control arm 52 of the lever 50. In the embodiment that is shown, the ratio between the length l and the length L is approximately ½, since the effective length l varies during the movement of the locking lever 50 between the locked position shown in FIG. 5 and the unlocked position shown in FIG. 6.

In FIGS. 5 and 6, the indexing stop 60 of the indexing arm 59 rests against an elastic element 63 that is formed by a metal rod that extends generally in a direction that is tangent to the arc described by the indexing stop 60 between locked positions (FIG. 5) and unlocked positions (FIG. 6). In addition, the elastic element 63 has a deformation 64 in the direction of the pivoting axis 51 that is located between the point of contact with the indexing stop 60 in locked position and the point of contact in unlocked position. Thus, when the locking lever 50 is moved from the locked position (FIG. 5) toward the unlocked position (FIG. 6), the indexing stop 60 causes an additional deformation of the elastic element 63 relative to its natural shape, which creates a hard point during the movement of the locking control 42.

The locking device 40 also comprises locking elements that are able to engage with one another and to become engaged by relative rotation between these elements. In the embodiment that is shown, a first locking element and a second locking element are provided for each of the first and second infusion chambers (11, 12).

The first locking element of the first infusion chamber 11 consists of the ring 20 that comprises, in addition to the flange 22 that is equipped with a driving pin 62, “L” guides 71. As can be seen better from FIG. 3, the “L” guides 71 are formed by openings that pass through the wall of the ring 20. The “L” guides 71 each have a first portion that extends longitudinally from the base 21 along the axis of the ring 20, such that this portion of the guides 71 opens from the side of the corresponding trough 16. A second portion of each guide 71 extends circumferentially in the wall of the ring 20, such that it defines a slot that is delimited between an upper portion of the ring 20 and a foot 74 that circumferentially extends the base 21 of the ring. The “L” guides 71 are, for example, four in number, and are uniformly distributed on the periphery of the ring 20.

The ring 20 is mounted to pivot by means of the sprayer 24 around a vertical axis VI that is stationary relative to the cover 3, which corresponds to the axis of symmetry of the ring 20. The pivoting of the locking lever 50 relative to the pivoting axis 51, which is parallel to the locking axis VI, therefore brings about a pivoting of the ring 20 of the first chamber 11 around its axis VI because of the connection between the driving pin 62 and the end portion 57 of the first driving arm 55.

The second locking element of the first infusion chamber 11 consists of the trough 16 that comprises lugs 77 that extend radially toward the outside from the periphery of the upper perimeter 18. As can be seen in FIG. 5, in which the frame 3a, the hood 3b and the rings 20 are not shown, the lugs 77 are, in this example, four in number and are uniformly distributed over the perimeter of the trough 16. The trough 16 is attached to the prominent part 7 of the housing, and consequently it is immobile relative to the second part of the housing that is formed by the platform 4.

The trough 16 has an outside diameter, beyond lugs 77, which is clearly smaller than the inside diameter of the ring 20, and the lugs 77 have a circumferential width that is less than the openings of the “L” guides 71, such that the first locking element that is formed by the ring 20 can be engaged on the second locking element that is formed by the trough 16 during the rocking of the cover 3 into a lowered position. When the cover 3 is thus lowered with a filter holder 15 in position in the infusion chamber 11, the collar 26 of the filter holder is tightened between the upper perimeter 18 of the trough 16 and the sealing joint 30 that rests against the flange 22 of the ring 20. The locking of the infusion chamber 11 is then obtained by moving the locking control 42 from the unlocked position shown in FIG. 6 to the locked position shown in FIG. 5. The lugs 77 are then engaged in the second portion of the “L” guides 71 thanks to the rotation of the ring 20 caused by the locking lever 50.

In the locked position that is shown in particular in FIG. 3, the lugs 77 rest by their inside face on the upper edge of the feet 74. The interaction of these contact surfaces between the lugs 77 and the guides 71 prevents any upward movement of the ring 20. The contact surfaces of the ring, formed by the upper edge of each of the feet 74, extend generally in a plane that is perpendicular to the locking axis VI, such that the increase of the pressure in the first infusion chamber 11 does not run the risk of producing sliding between the contact surfaces by rotation of the ring 20 toward the unlocked position. However, it is conceivable to produce the feet 74 in the form of inclined ramps so as to increase the tightening between the trough 16 and the ring 20 during locking.

For the purpose of also reducing the risks of unlocking under the effect of pressure, the contact surface that is formed by the upper edge of a foot 74 of the ring 20 has a projection 75, while the contact surface that is formed by the lower face of a lug 77 has a recess 78. The projections 75 and the recesses 78 are arranged on the corresponding contact surfaces so as to come together when the ring 20 is in a locked position relative to the trough 16. The interaction of these recesses 78 and these projections 75 ensures that the torque that is exerted on the ring 20 in order to leave the locked position is all the greater the greater the pressure in the infusion chamber.

The second infusion chamber 12 also comprises a ring 20 and a trough 16 that are absolutely identical to those described above in relation to the first infusion chamber. The ring 20 of this second chamber 12 also comprises a driving pin 62 that works with the second driving arm 56 of the lever 50, in a manner that is completely analogous to the first driving arm 55. Thus, the ring 20 and the trough 16 of the second infusion chamber 12 form a first locking element and a second locking element that rotate relative to a second locking axis V2, in a manner that is completely analogous to the same locking elements of the first infusion chamber 11.

It will be noted that the pivoting axis 51 and the first and second locking axes (V1, V2) are parallel and aligned in the same straight line, as can be seen in FIGS. 5 and 6. In addition, the pivoting axis 51 intersects the segment connecting the first and second locking axes (V1, V2) in the middle of the latter. The first and second driving arms (55, 56) of the lever 50 are symmetrical relative to the pivoting axis 51 of the latter. Thus, a simultaneous rotation in the same direction and of the same amplitude of the two rings 20 that are respectively combined with the two infusion chambers (11, 12) during the pivoting of the locking lever 50 is obtained.

It will also be noted that the position of the first and second driving arms (55, 56) is symmetrical relative to the segment that connects the locking axes (V1, V2) or else relative to the plane that comprises the axes (V1, V2), between the locked position that is shown in FIG. 5 and the unlocked position that is shown in FIG. 6. This arrangement makes it possible to preserve the longest possible effective length l of each of the driving arms (55, 56) during the pivoting of the locking lever 50 between the locked and unlocked positions. It will also be noted that the effective length l of each driving arm (55; 56) is identical in the locked and unlocked positions, thus making it possible to exert the same torque to be transmitted to the rings 20 to remove either of them from these positions.

As can be seen in FIGS. 5 and 6, the control arm 52 of the lever 50 does not form a right angle with the driving arms (55, 56) of said lever, although the slide 45 that guides the movement of the unlocking control 42 is parallel to the segment that connects the locking axes (V1, V2). Actually, the control arm 52 of the lever 50 is offset by approximately ten degrees relative to the line that is perpendicular to the driving arms (55, 56). This offset angle is determined such that the control button 43 is located in locked position in the middle of the front face of the cover 3 and freely offset toward the left in unlocked position, as can be noted in FIGS. 1 and 2. The movement of the control button 43 between a central position and a clearly eccentric position makes it possible for the user to identify more intuitively the locked and unlocked positions of the control 42.

When the user wants to prepare an infusion, he places one or two filter holders 15 that contain a dosette in the infusion chamber or chambers (11, 12), then he lowers the cover (3) with one hand. The rings 20 of the first and second infusion chambers (11, 12) engage naturally on the corresponding troughs 16 because of the movement in an arc by the cover 3, which is guided by the hinges 5 toward the prominent part 7 of the platform 4. The lugs 77 of the troughs 16 then penetrate the first portion of the guides 71 of the rings 20. The user then moves the control button 43 toward the right, for example with the thumb of the other hand, to make the button pass from the unlocked position, shown in FIG. 6, to the locked position, shown in FIG. 5. By means of the locking lever 50, the movement of the locking control 42 produces a simultaneous counter-clockwise rotation of the two rings 20 that are associated respectively with the first and second infusion chambers (11, 12). The contact surfaces of the lugs 77 of the troughs 16 are engaged with the contact surfaces of the feet 74 of the rings 20. Any release movement of the rings 20 along their respective locking axes (V1, V2) is then impossible.

Once the infusion is prepared, the user moves the control button 43 toward the left to make it pass from the locked position (FIG. 5) to the unlocked position (FIG. 6). During this movement of the button 43, the locking lever 50 produces a simultaneous clockwise rotation of the two rings 20 that are associated respectively with the two infusion chambers (11, 12); this rotation of the rings 20 brings about the release of the feet 74 of the rings 20 relative to the lugs 77 of the troughs 16. The cover 3 then pivots upward in an open position, preferably automatically thanks to elastic return elements that are arranged in the hinges 5 that form the joint between the cover 3 and the platform 4. The filter holder or filter holders 15 that are placed in the infusion chambers (11, 12) can then be gripped by their handle 27 to throw away the used dosette.

Of course, the embodiment that is described above is in no way limiting, whereby numerous modifications can be provided without exceeding the scope of this invention. Among the latter, it is possible to cite in particular the possibility of providing only a single infusion chamber, the fact of providing a detachable cover relative to the platform and not articulated, the fact of providing only a single first locking element and a single second locking element to lock a number of infusion chambers, or else the possibility of producing these locking elements in the form of separate pieces from pieces that delimit the infusion chambers and, for example, are located between the latter. Other modifications can also be provided and in particular can reverse the position of the lugs of the “L” guides relative to the first and second locking elements, or can arrange the first rotary locking element on the part of the housing that forms the platform, whereby the second locking element is attached to a moving part of the housing that comes in the form of a cover, slide, etc.

1. Machine for preparing an infusion that comprises:
A housing (2) that comprises at least a first part (3) and a second part (4) that can be moved relative to one another;
A pressurized hot water generator that is arranged inside the housing;
At least a first infusion chamber (11) that is delimited by the first and second parts (3, 4) of the housing and fed by said generator to infuse a product that is placed inside; and
A device (40) for locking the infusion chamber (11) that comprises a locking control (42) that is connected to a locking lever (50) and that comprises at least a first locking element (20) that is mounted to rotate on an axis (VI), called locking, connected to the first part (3) of the housing, and a second locking element (16) that is attached to the second part (4) of the housing, whereby said first locking element (20) is suitable for being moved by rotation between a locked position in which said first (20) and second (16) locking elements are engaged with one another, and an unlocked position in which said first (20) and second (16) locking elements can be disengaged from one another, characterized in that the locking lever (50) is mounted to pivot around a stationary axis (51) relative to the first part (3) of the housing and is connected to the first locking element (20), and said locking element (50) is suitable for bringing said first locking element (20) into rotation around the locking axis (V1) relative to the first part (3) of the housing and for exerting on said first locking element (20) a torque that is amplified relative to the torque that is exerted on said lever (50) by the locking control (42).

2. Machine according to claim 1, wherein the locking lever (50) comprises a control arm (52) that extends from the pivoting axis (51) to a portion (53) that is connected to the locking control (42), and a first driving arm (55) that extends from said pivoting axis (51) to a portion (57) that is connected to the first locking element (20) at an eccentric point relative to the locking axis (V1) of said first element (20), whereby the length (L) of the control arm (52) is greater than the length (l) of the driving arm (55).

3. Machine according to claim 1, wherein one (16) of said first and second locking elements comprises lugs (77) that extend radially relative to the locking axis (V1), while the other (20) of said first and second locking elements comprises “L” guides (71) formed in a ring (20) that is coaxial to the locking axis (V1), whereby said guides (71) each have a first longitudinal portion that opens from the side of the locking element (16) that is equipped with lugs, followed by a second circumferential portion in which the corresponding lug (77) engages with the guide (71).

4. Machine according to claim 3, wherein the guides (71) and the lugs (77) have mutual contact surfaces that respectively have mating projections (75) and recesses (78) when the first and second locking elements (20, 16) are in locked position.

5. Machine according to claim 1, wherein the locking lever (50) has an indexing arm (59) that extends from the pivoting axis (51) to an indexing stop (60) that rests against an elastically deformable element (63) that is connected to the first part (3) of the housing, whereby the pivoting of the lever (50) from the locked or unlocked position causes a deformation of the elastic element (63) in opposition to its return force.

6. Machine according to claim 1, wherein the first part (3) of the housing has a guide (45) along which the locking control (42) can be translated, whereby said locking control (42) is connected in an articulated manner to the locking lever (50).

7. Machine according to claim 2, wherein a second infusion chamber (12) is provided, and wherein the locking lever (50) is also connected to a first locking element (20) of the second chamber (12), whereby said lever (50) is suitable for simultaneously bringing into rotation the first respective locking elements (20) of the first (11) and second (12) chambers around their respective locking axes (V1, V2), relative to the first part (3) of the housing.

8. Machine according to claim 7, wherein the locking lever (50) comprises a second driving arm (56) that is connected to the first locking element (20) of the second infusion chamber (12) and that extends from the pivoting axis (51) in a collinear direction to the first driving arm (55), preferably over the same length, whereby the pivoting axis (51) of the lever is parallel to the locking axes (V1, V2) of the first and second respective locking elements (20) of the first (11) and second (12) infusion chambers and is located approximately in the center of said locking axes (V1, V2).

9. Machine according to claim 8, wherein the angle that is formed between the first and second driving arms (55, 56) of the lever (50), on the one hand, and the control arm (52) of said lever (50), on the other hand, is determined based on the locked and unlocked positions of the locking control (42), such that said first and second driving arms (55, 56) are in approximately symmetrical positions relative to the plane that comprises the locking axes (V1, V2) between the locked position and the unlocked position of said locking control (42).

10. Machine according to claim 1, wherein the second part of the housing constitutes a platform (4) that is mounted on the front of the housing and the first part of the housing constitutes an upper cover (3) that is mounted in an articulated manner on said platform (4).

11. Machine according to claim 2, wherein one (16) of said first and second locking elements comprises lugs (77) that extend radially relative to the locking axis (V1), while the other (20) of said first and second locking elements comprises “L” guides (71) formed in a ring (20) that is coaxial to the locking axis (V1), whereby said guides (71) each have a first longitudinal portion that opens from the side of the locking element (16) that is equipped with lugs, followed by a second circumferential portion in which the corresponding lug (77) engages with the guide (71).

12. Machine according to claim 2, wherein the locking lever (50) has an indexing arm (59) that extends from the pivoting axis (51) to an indexing stop (60) that rests against an elastically deformable element (63) that is connected to the first part (3) of the housing, whereby the pivoting of the lever (50) from the locked or unlocked position causes a deformation of the elastic element (63) in opposition to its return force.

13. Machine according to claim 2, wherein the first part (3) of the housing has a guide (45) along which the locking control (42) can be translated, whereby said locking control (42) is connected in an articulated manner to the locking lever (50).

14. Machine according to claim 1, wherein a second infusion chamber (12) is provided, and wherein the locking lever (50) is also connected to a first locking element (20) of the second chamber (12), whereby said lever (50) is suitable for simultaneously bringing into rotation the first respective locking elements (20) of the first (11) and second (12) chambers around their respective locking axes (V1, V2), relative to the first part (3) of the housing.

15. Machine according to claim 2, wherein the second part of the housing constitutes a platform (4) that is mounted on the front of the housing and the first part of the housing constitutes an upper cover (3) that is mounted in an articulated manner on said platform (4).
